(19) United States
(12) Patent Application Publication
(10) Pub. No.: US 2022/0018727 A1
(43) Pub. Date: Jan. 20, 2022

(54) PRESSURE SENSOR

(71) Applicant: MIKUNI CORPORATION, Tokyo (JP)

(72) Inventor: Satoshi KANETA, Iwate (JP)

(73) Assignee: MIKUNI CORPORATION, Tokyo (JP)

(21) Appl. No.: 17/330,366

(22) Filed: May 25, 2021

(30) Foreign Application Priority Data
Jul. 20, 2020 (JP) 2020-123759

(51) Int. Cl. G01L 23/10; G01L 23/26; G01L 19/06

(52) U.S. Cl. CPC G01L 23/10; G01L 19/0681; G01L 23/26

(57) ABSTRACT

A pressure sensor is provided and includes housings that are formed to have a tubular shape; a pressure measurement member that is accommodated inside the housing and includes a piezoelectric substance; a diaphragm that has a flexible plate-shaped part fixed to a tip side of the housings and a transfer part protruding on an axis to transfer a load to the pressure measurement member; and a heat shielding plate that is held by the housings such that the diaphragm is covered, comes into contact with the diaphragm in a central region corresponding to the transfer part, and defines an annular void between the heat shielding plate and the diaphragm in a region other than the central region.

### CROSS REFERENCE TO RELATED APPLICATIONS

This application claims the priority benefit of Japanese Patent Application No. 2020-123759, filed on Jul. 20, 2020. The entirety of the above-mentioned patent application is hereby incorporated by reference herein and made a part of this specification.

### BACKGROUND

### Technical Field

The disclosure relates to a pressure sensor for detecting a pressure of a pressure medium and particularly relates to a pressure sensor for detecting a pressure of a high-temperature pressure medium such as a combustion gas inside a combustion chamber of an engine.

### Description of Related Art

Regarding a pressure sensor in the related art, a pressure sensor including a tubular casing, a diaphragm that is bonded to a tip side of the casing and bent in response to a received pressure, a sensor part that is disposed inside the casing, a connection part that connects the diaphragm and the sensor part to each other, and a heat receiving part that serves as a heat shielding plate which is disposed in contact with the entire outer surface of the diaphragm and of which a central part is welded to the diaphragm is known (for example, Patent Document 1: Japanese Patent Application Laid-Open No. 2017-40516).

In this pressure sensor, since the entire heat shielding plate comes into contact with the diaphragm, heat transferred to the heat shielding plate is likely to be transferred to the diaphragm. In addition, since a central region of the heat shielding plate is welded to the diaphragm, a clearance is likely to be generated between the diaphragm and the heat shielding plate in an outer circumferential region of the diaphragm so that the diaphragm is directly exposed to a high-temperature combustion gas through the generated clearance, and thus the influence of heat cannot be curbed or prevented.

Further, if the diaphragm receives the influence of heat, distortion due to thermal expansion occurs and the accuracy of the sensor part is degraded. In addition, if the clearance becomes large due to aging, the accuracy of the sensor part is further degraded, and there is concern that the heat shielding plate may fall off due to deterioration of a welded part.

The disclosure is to provide a pressure sensor capable of curbing thermal distortion by protecting a diaphragm from a high-temperature pressure medium and detecting a pressure of the high-temperature pressure medium with high accuracy by curbing or preventing degradation of sensor accuracy due to influence of heat.

### SUMMARY

According to one embodiment of the disclosure, a pressure sensor is provided, including a cylindrical housing that defines an axis; a pressure measurement member that is accommodated inside the cylindrical housing and includes a piezoelectric substance; a diaphragm that has a flexible plate-shaped part fixed to a tip side of the cylindrical housing and a transfer part protruding on the axis to transfer a load to the pressure measurement member; and a heat shielding plate that is held by the cylindrical housing such that the diaphragm is covered, comes into contact with the diaphragm in a central region corresponding to the transfer part, and defines an annular void between the heat shielding plate and the diaphragm in a region other than the central region.

### BRIEF DESCRIPTION OF THE DRAWINGS

FIG. 1 is a perspective view illustrating an appearance of a first embodiment of a pressure sensor according to the disclosure.

FIG. 2 is a cross-sectional view through an axis of the pressure sensor illustrated in FIG. 1.

FIG. 3 is an exploded perspective view of a sensor module and a heat shielding plate included in the pressure sensor illustrated in FIG. 1.

FIG. 4 is a partial cross-sectional view of the pressure sensor illustrated in FIG. 1.

FIG. 5 is a partial cross-sectional view of the pressure sensor at a position rotated 90 degrees around an axis S with respect to the cross section illustrated in FIG. 4.

FIG. 6 is a partial cross-sectional view illustrating a housing, a diaphragm, and the heat shielding plate in the first embodiment.

FIG. 7 illustrates heat shielding effects of the heat shielding plate according to the disclosure and is a graph illustrating a temperature distribution of the diaphragm when a clearance between the heat shielding plate and the diaphragm is changed.

FIG. 8 is a partial cross-sectional view illustrating the housing, the diaphragm, and the heat shielding plate in a second embodiment.

FIG. 9 is an exploded perspective view of the sensor module, the heat shielding plate, and an annular member in a third embodiment.

FIG. 10 is a partial cross-sectional view illustrating the housing, the diaphragm, the heat shielding plate, and the annular member in the third embodiment.

FIG. 11 is a perspective view illustrating a modification example of a heat shielding plate included in the pressure sensor according to the disclosure.

### DESCRIPTION OF THE EMBODIMENTS

Hereinafter, embodiments of the disclosure will be described with reference to the accompanying drawings.

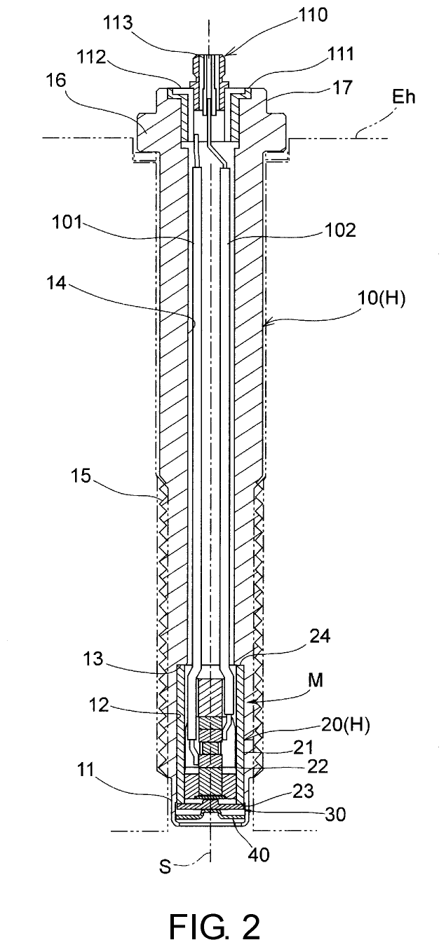

As illustrated in FIG. 2, a pressure sensor according to a first embodiment is attached to a cylinder head Eh of an engine and detects a pressure of a combustion gas as a pressure medium inside a combustion chamber.

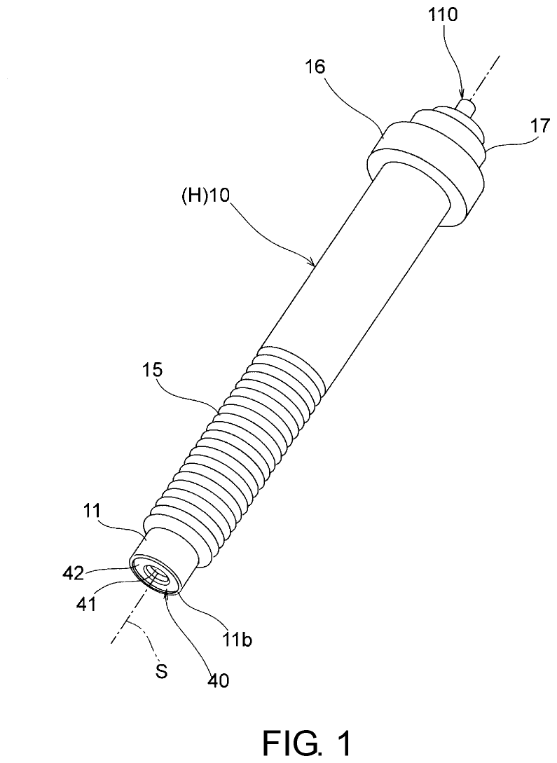

As illustrated in FIGS. 1 to 3, the pressure sensor according to the first embodiment includes an external housing 10 and a sub-housing 20 serving as a cylindrical housing H which defines an axis S, a diaphragm 30, a heat shielding plate 40, a holding plate 50, a positioning member 60, a heat insulation member 70, a pressure measurement member 80, a preload applying member 90, a lead wire 101 serving as a first conductor, a lead wire 102 serving as a second conductor, and a connector 110.

Here, the pressure measurement member 80 is constituted of a first electrode 81, a piezoelectric substance 82, and a second electrode 83 which are stacked in this order in an axis S direction from a tip side of the housing.

The preload applying member 90 is constituted of a fixing member 91 and an insulation member 92.

Using a metal material such as precipitation hardening stainless steel or ferritic stainless steel, as illustrated in FIGS. 1 and 2, the external housing 10 is formed to have a cylindrical shape extending in the axis S direction and includes a tip tubular part 11, a fitting inner circumferential wall 12, a step part 13, a penetration path 14, a male screw part 15 formed on an outer circumferential surface, a flange part 16, and a connector coupling part 17.

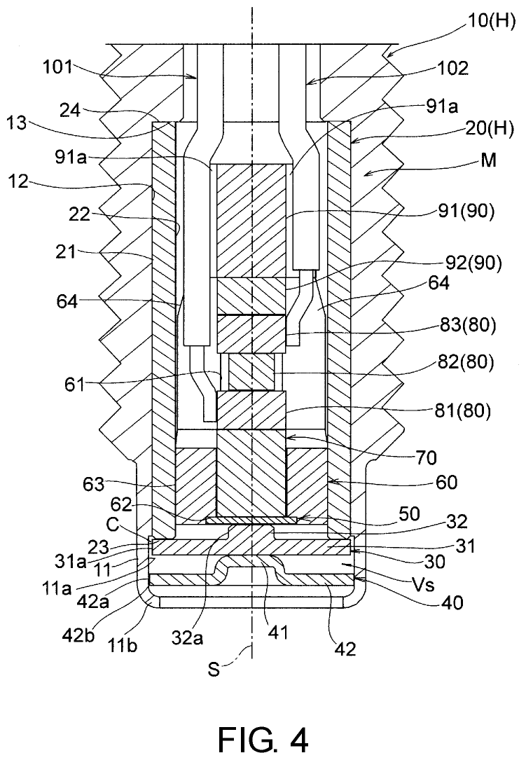

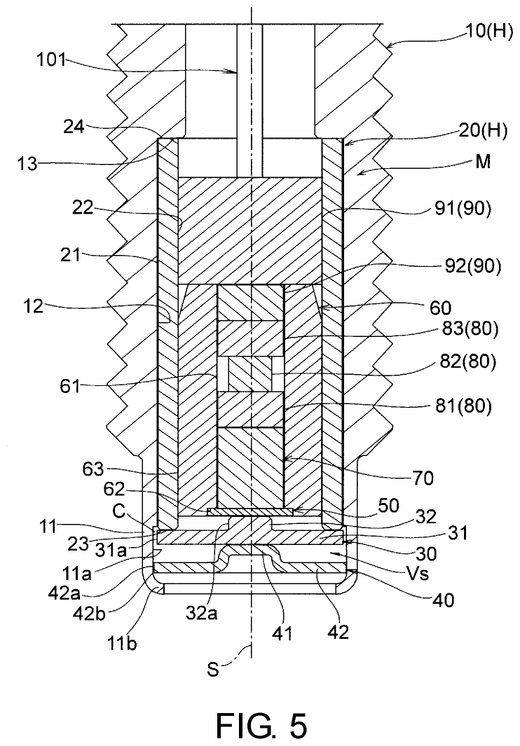

As illustrated in FIGS. 4 and 5, the tip tubular part 11 is a region for accommodating the diaphragm 30 and the heat shielding plate 40, and an inner diameter dimension of an inner circumferential wall 11a is formed to be larger than an outer diameter dimension of an outer circumferential wall 21 of the sub-housing 20.

In addition, the tip tubular part 11 is formed to extend to the tip side in the axis S direction beyond an end surface 23 on an outer side in a radial direction from the end surface 23 of the sub-housing 20 to which a flexible plate-shaped part 31 of the diaphragm 30 is fixed in the axis S direction.

Using a metal material such as precipitation hardening stainless steel or ferritic stainless steel, as illustrated in FIGS. 4 and 5, the sub-housing 20 is formed to have a cylindrical shape extending in the axis S direction and includes the outer circumferential wall 21 fitted to the fitting inner circumferential wall 12, an inner circumferential wall 22 centering on the axis S, the end surface 23, and an end surface 24.

The end surface 23 is a region that an outer circumferential edge region of the flexible plate-shaped part 31 of the diaphragm 30 abuts and is fixed in the axis S direction.

The end surface 24 is a region that the step part 13 of the external housing 10 abuts.

Further, the sub-housing 20 is fitted to an inner side of the external housing 10 and is fixed thereto by welding or the like in a state in which the diaphragm 30, the holding plate 50, the positioning member 60, the heat insulation member 70, the pressure measurement member 80, the preload applying member 90, the lead wire 101, and the lead wire 102 are assembled.

For example, the diaphragm 30 is formed using a metal material such as a precipitation hardening stainless steel sheet having a plate thickness within a range of approximately 0.2 mm to 0.4 mm (SUS630) and includes the flexible plate-shaped part 31 and a transfer part 32 formed to be connected to the flexible plate-shaped part 31 as illustrated in FIGS. 4 to 6.

The flexible plate-shaped part 31 is formed to have an elastically deformable disk shape with an outer diameter equivalent to the outer diameter dimension of the sub-housing 20, and the outer circumferential edge region thereof abuts the end surface 23 of the sub-housing 20 in the axis S direction and is fixed thereto by welding or the like.

The transfer part 32 is formed to have a pillar shape centering on the axis S on the inner side of the flexible plate-shaped part 31 and protruding toward the inside of the sub-housing 20 in the axis S direction.

An outer circumferential wall 32a of the transfer part 32 is disposed with an annular void between the transfer part 32 and the inner circumferential wall 22 of the sub-housing 20.

Further, the transfer part 32 plays a role of transferring a force received by the diaphragm 30 to the piezoelectric substance 82 via the holding plate 50, the heat insulation member 70, and the first electrode 81.

In addition, since the transfer part 32 is provided, an amount of heat transfer of heat transferred to the diaphragm 30 is limited by the transfer part 32 having a narrowed area when the heat is transferred to the inside of the sub-housing 20. Therefore, the amount of heat transfer moving from the diaphragm 30 to the inside can be curbed.

The diaphragm 30 having the foregoing form defines an effective part A in which an annular region from the outer circumferential wall 32a of the transfer part 32 to the inner circumferential wall 22 of the sub-housing 20 is elastically deformed in an effective manner and is elastically deformed in the axis S direction upon reception of a load corresponding to a pressure of a combustion gas.

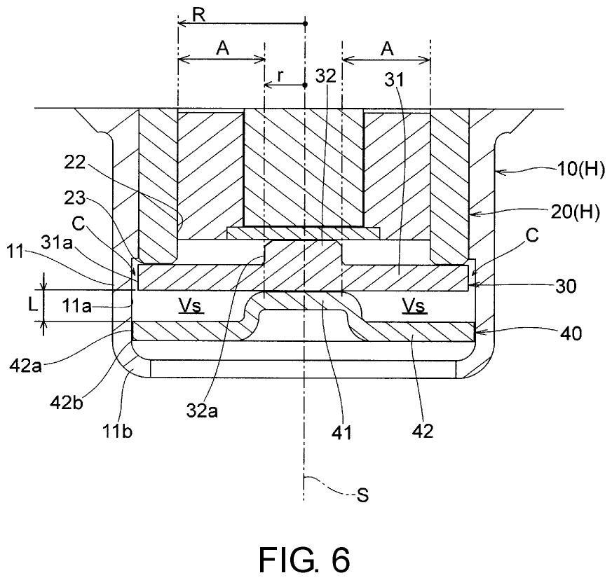

Specifically, as illustrated in FIG. 6, when a radius of the outer circumferential wall 32a of the transfer part 32 is r and a radius of the inner circumferential wall 22 of the sub-housing 20 is R centering on the axis S, the effective part A is a toric region excluding a circular region having a diameter 2R to a circular region having a diameter 2r.

That is, the effective part A is a region which is elastically deformed with favorable reproducibility in response to a received pressure and directly affects the sensor accuracy of the pressure measurement member 80 when the diaphragm 30 receives a pressure of the pressure medium.

On the other hand, there is concern that the effective part A may thermally expand upon reception of the influence of heat of a combustion gas and apply a deformation force to the transfer part 32 in addition to a pressure of the pressure medium. Therefore, the effective part A is also a region which is desirable to be subjected to heat shielding.

For example, the heat shielding plate 40 is press-formed using a metal material such as an austenitic stainless steel sheet having a plate thickness within a range of approximately 0.3 mm to 0.4 mm (SUS304) and includes a disk-shaped contact part 41 and an annular isolation part 42.

The disk-shaped contact part 41 is formed to have a disk shape centering on the axis S and coming into contact with a region having a contour corresponding to an outer diameter (the outer circumferential wall 32a) of the transfer part 32 in a direction perpendicular to the axis S, that is, coming into contact with the diaphragm 30 in a central region (a circular region having the diameter 2r) corresponding to the transfer part 32.

The annular isolation part 42 has a toric plate shape with a cylinder formed to be connected to the disk-shaped contact part 41, bent in the axis S direction, and expanding in the radial direction and is disposed in a manner of being isolated from the flexible plate-shaped part 31 by a gap L to define an annular void Vs between the annular isolation part 42 and the diaphragm 30 in a region other than the central region corresponding to the transfer part 32, that is, such that it is disposed in a manner of being isolated from the flexible plate-shaped part 31 and the annular void Vs is defined between the annular isolation part 42 and the diaphragm 30.

As the gap L increases, the void Vs increases and a heat insulating effect is enhanced. However, in consideration of miniaturization, limitations on a layout, and a required heat insulating effect, the gap L is set to have a value within a range of approximately one to two times the plate thickness of the heat shielding plate 40.

The gap L is not limited to the foregoing value and may be set to have other values as long as other limitations are allowed.

Regarding a material of the heat shielding plate 40, it is preferable to use a material having a low heat conductivity and excellent durability. For example, in addition to the foregoing stainless steel, a nickel alloy, an iron-based alloy, a titanium alloy, or the like may be used. For example, the heat conductivity is preferably 15 W/m·K or lower and more preferably 5 W/m·K or lower.

In addition, regarding a material of the heat shielding plate 40, when a material having a lower heat conductivity than the diaphragm 30 is used, the amount of heat transfer transferred from a high-temperature pressure medium to the diaphragm 30 via the heat shielding plate 40 can be effectively curbed.

Further, as illustrated in FIGS. 4 and 5, the heat shielding plate 40 is inserted into the tip tubular part 11 of the external housing 10, the disk-shaped contact part 41 overlaps the central region of the diaphragm 30 such that it comes into contact therewith from the outer side in the axis S direction, a tip part 11b of the tip tubular part 11 is subjected to caulking processing, and in a state in which an outer circumferential surface 42a of the annular isolation part 42 comes into contact with the inner circumferential wall 11a of the tip tubular part 11, an outer circumferential edge part 42b is in a state of being held by the external housing 10.

That is, the heat shielding plate 40 is disposed such that the diaphragm 30 exposed to the high-temperature pressure medium (high-temperature combustion gas) is covered from the outer side in the axis S direction and is held by the external housing 10 without being fixed thereto by welding or the like while the void Vs is sealed.

Since the heat shielding plate 40 having the foregoing constitution is formed as a member independent from the diaphragm 30, it repeats expansion and contraction alone in response to heat received from the high-temperature pressure medium and releases heat. Since they are separate members, a thermal barrier is also formed between the heat shielding plate 40 and the diaphragm 30, and the heat shielding plate 40 functions to curb heat transfer to the diaphragm 30.

Particularly, since the heat shielding plate 40 is formed such that the annular void Vs is defined between the heat shielding plate 40 and the effective part A of the diaphragm 30, a heat insulating effect can be enhanced due to a gas layer such as air inside the void Vs, and the amount of heat transfer transferred to the diaphragm 30 can be curbed.

In addition, since the heat shielding plate 40 is not fixed to the diaphragm 30 or the external housing 10 by welding or the like and is held by simply coming into contact therewith, even if thermal deformation occurs, the influence of thermal deformation of the heat shielding plate 40 on the diaphragm 30 or the external housing 10 can be curbed or prevented.

Accordingly, distortion of the diaphragm 30 due to thermal expansion can be curbed, degradation of the sensor accuracy of the pressure measurement member 80 due to influence of heat can be curbed or prevented, and a pressure of the high-temperature pressure medium can be detected with high accuracy.

Using a metal material such as precipitation hardening stainless steel or ferritic stainless steel, as illustrated in FIGS. 4 and 5, the holding plate 50 is formed to have a disk shape with an outer diameter larger than the outer diameter of the transfer part 32.

Further, the holding plate 50 is sandwiched between the transfer part 32 of the diaphragm 30 and the heat insulation member 70, holds the positioning member 60 such that it is isolated from the flexible plate-shaped part 31, and plays a role of defining a void between the flexible plate-shaped part 31 of the diaphragm 30 and the positioning member 60.

According to this, due to the presence of the foregoing void, heat transfer from the diaphragm 30 toward the inside of the sub-housing 20 can be efficiently curbed.

The holding plate 50 may be formed of an insulating material or other materials as long as the material has a high mechanical rigidity.

Using an insulating material having electrical insulating properties and thermal insulating properties, as illustrated in FIGS. 4 and 5, the positioning member 60 is formed to have a cylindrical shape extending in the axis S direction and includes a penetration hole 61, a fitting recessed part 62, an outer circumferential surface 63, and two cutout grooves 64 allowing lead wires 101 and 102 to pass therethrough.

The penetration hole 61 is formed as a circular hole centering on the axis S and extending in the axis S direction.

The fitting recessed part 62 is formed as a circular recessed part centering on the axis S to receive the holding plate 50.

The outer circumferential surface 63 is formed as a cylinder surface centering on the axis S to be fitted to the inner circumferential wall 22 of the sub-housing 20.

The two cutout grooves 64 have the same depth dimension in the axis S direction and are provided at point-symmetrical positions 180 degrees from each other around the axis S.

An insulating material forming the positioning member 60 preferably has a large thermal capacity and a low heat conductivity. For example, the heat conductivity is preferably 15 W/m·K or lower and more preferably 5 W/m·K or lower. Examples of a specific material include ceramic such as quartz glass, steatite, zirconia, cordierite, forsterite, mullite, or yttria, or a conductive material subjected to insulation processing.

Further, the positioning member 60 is supported by the holding plate 50 abutting the transfer part 32, is fitted to the inner circumferential wall 22 of the sub-housing 20, and holds the heat insulation member 70, the pressure measurement member 80 constituted of the first electrode 81, the piezoelectric substance 82, and the second electrode 83, and the insulation member 92 which are subjected to positioning in a stacked state inside the penetration hole 61.

That is, the positioning member 60 is disposed on the inner side of the sub-housing 20 forming a portion of the housing and plays a role of performing positioning of the heat insulation member 70, the pressure measurement member 80, and the insulation member 92 on the axis S of the housing by fitting these into the penetration hole 61.

Therefore, based on the positioning member 60, the heat insulation member 70, and the first electrode 81, the piezoelectric substance 82, and the second electrode 83 constituting the pressure measurement member 80 can be subjected to positioning on the axis S and easily assembled while insulating properties of both the electrodes are ensured.

The heat conductivity of the positioning member 60 is preferably equivalent to the heat conductivity of the heat insulation member 70 and lower than the heat conductivity of the insulation member 92. Accordingly, the positioning member 60 can also function as a heat insulation member.

Moreover, since the positioning member 60 is disposed in a manner of being supported by the holding plate 50 and isolated from the flexible plate-shaped part 31 of the diaphragm 30 and is formed such that the heat insulation member 70 is surrounded, heat transfer from the diaphragm 30 and the wall part of the housing toward the piezoelectric substance 82 can be more efficiently curbed.

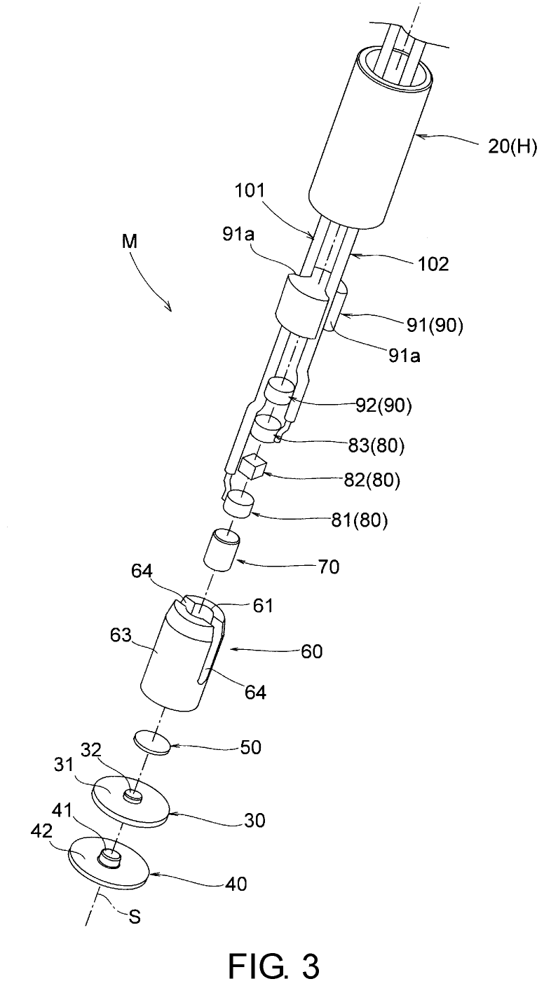

Using an insulating material having electrical insulating properties and thermal insulating properties, as illustrated in FIGS. 3 to 5, the heat insulation member 70 is formed to have a pillar shape with an outer diameter equivalent to the outer diameter of the first electrode 81.

An insulating material forming the heat insulation member 70 preferably has a large thermal capacity and a low heat conductivity. For example, the heat conductivity is preferably 15 W/m·K or lower and more preferably 5 W/m·K or lower. Examples of a specific material include ceramic such as quartz glass, steatite, zirconia, cordierite, forsterite, mullite, or yttria, or a conductive material subjected to insulation processing.

Further, the heat insulation member 70 is disposed in a tight contact manner between the holding plate 50 abutting the transfer part 32 of the diaphragm 30 and the first electrode 81 on the inner side of the sub-housing 20.

Accordingly, the heat insulation member 70 functions to curb heat transfer from the diaphragm 30 to the first electrode 81.

That is, a load due to the pressure received by the diaphragm 30 is transferred to the piezoelectric substance 82 via the holding plate 50, the heat insulation member 70, and the first electrode 81. On the other hand, heat transfer from the diaphragm 30 to the first electrode 81 is curbed by the heat insulation member 70.

Thus, the influence of heat on the piezoelectric substance 82 adjacent to the first electrode 81 is curbed, fluctuation of a reference point (zero point) of a sensor output can be prevented, and expected sensor accuracy can be obtained.

The pressure measurement member 80 has a function of detecting a pressure and includes the first electrode 81, the piezoelectric substance 82, and the second electrode 83 which are stacked in this order in the axis S direction from the tip side on the inner side of the sub-housing 20 as illustrated in FIGS. 3 to 5.

Using a conductive metal material such as precipitation hardening stainless steel or ferritic stainless steel, the first electrode 81 is formed to have a pillar shape or a disk shape with an outer diameter fitted into the penetration hole 61 of the positioning member 60.

Further, the first electrode 81 is disposed such that one surface comes into tight contact with the heat insulation member 70 and the other surface comes into tight contact with the piezoelectric substance 82 inside the penetration hole 61 of the positioning member 60.

The piezoelectric substance 82 is formed to have a quadrangular prism shape with dimensions not coming into contact with the penetration hole 61 of the positioning member 60.

Further, the piezoelectric substance 82 is disposed such that one surface comes into tight contact with the first electrode 81 and the other surface comes into tight contact with the second electrode 83 inside the penetration hole 61 of the positioning member 60.

Accordingly, the piezoelectric substance 82 outputs an electrical signal on the basis of distortion due to a load received in the axis S direction.

Regarding the piezoelectric substance 82, ceramic such as zinc oxide (ZnO), barium titanate (BaTiO₃), or lead zirconate titanate (PZT), crystal, or the like is applied.

Using a conductive metal material such as precipitation hardening stainless steel or ferritic stainless steel, the second electrode 83 is formed to have a pillar shape or a disk shape with an outer diameter fitted into the penetration hole 61 of the positioning member 60.

Further, the second electrode 83 is disposed such that one surface comes into tight contact with the piezoelectric substance 82 and the other surface comes into tight contact with the insulation member 92 inside the penetration hole 61 of the positioning member 60.

As illustrated in FIGS. 3 to 5, the preload applying member 90 is disposed on the inner side of the sub-housing 20 forming a portion of the housing, applies a preload by pressurizing the pressure measurement member 80 toward the diaphragm 30, plays a role of imparting linear characteristics as a sensor to the pressure measurement member 80, and is constituted of the fixing member 91 and the insulation member 92.

Using a metal material such as precipitation hardening stainless steel or ferritic stainless steel, the fixing member 91 is formed to have substantially a solid pillar shape centering on the axis S and having no cavity or lightening present in the central region occupying an area equivalent to or larger than the penetration hole 61.

In addition, the fixing member 91 includes two vertical grooves 91a in an outer circumferential region deviating from the central region.

The two vertical grooves 91a are formed in a lightened manner at point-symmetrical positions 180 degrees from each other around the axis S to allow the lead wires 101 and 102 to pass therethrough respectively.

Using an insulating material having high electrical insulating properties, the insulation member 92 is formed to have a pillar shape or a disk shape with an outer diameter fitted into the penetration hole 61 of the positioning member 60.

That is, the insulation member 92 is formed to have a solid shape having no cavity or lightening present in the entire region occupying the area equivalent to the penetration hole 61.

Further, the insulation member 92 maintains electrical insulating between the second electrode 83 and the fixing member 91 and functions to guide heat transferred to the piezoelectric substance 82 to the fixing member 91 for heat release.

In this embodiment, the heat insulation member 70, the first electrode 81, the second electrode 83, and the insulation member 92 are formed to have substantially the same outer diameter dimension and substantially the same thickness dimension, that is, substantially the same shape.

An insulating material of the insulation member 92 preferably has a small thermal capacity and a high heat conductivity. Examples of a specific material include ceramic such as alumina, sapphire, aluminum nitride, or silicon carbide, or a conductive material subjected to insulation processing.

In addition, the insulation member 92 preferably has a heat conductivity higher than the heat conductivity of the heat insulation member 70, for example, 30 W/m·K or higher. Moreover, the insulation member 92 preferably has a smaller thermal capacity than the heat insulation member 70.

According to this, the amount of heat transfer transferred to the piezoelectric substance 82 is curbed as much as possible by the heat insulation member 70, whereas heat transferred to the piezoelectric substance 82 passes through the insulation member 92 such that heat release can be promoted.

Regarding assembly of the preload applying member 90 having the foregoing constitution, as illustrated in FIGS. 4 and 5, the insulation member 92 is fitted into the penetration hole 61 such that it abuts the second electrode 83 in a state in which the pressure measurement member 80 is disposed inside the positioning member 60. Further, the insulation member 92 abuts the fixing member 91 such that the pressure measurement member 80 is pressed toward the diaphragm 30 in the axis S direction, and the fixing member 91 is fixed to the sub-housing 20 by welding or the like in state in which a preload is applied thereto.

In this manner, linear characteristics as a sensor can be imparted to the pressure measurement member 80 by applying a preload using the preload applying member 90. In addition, the insulation member 92 maintains electrical insulating between the second electrode 83 and the fixing member 91 and functions to guide heat transferred to the piezoelectric substance 82 to the fixing member 91 for heat release. Therefore, the insulation member 92 preferably has a high heat conductivity and a small thermal capacity as described above.

As illustrated in FIGS. 2 and 4, the lead wire 101 is electrically connected to the first electrode 81 of the pressure measurement member 80, passes through one cutout groove 64 of the positioning member 60, one vertical groove 91a of the fixing member 91, and the penetration path 14 of the external housing 10, and is guided to the connector 110 in a state of being insulated from the external housing 10 and derived.

That is, the first electrode 81 is connected to a terminal 112 of the connector 110 via the lead wire 101 and is electrically connected to an electric circuit on a ground side (negative side) via an external connector.

As illustrated in FIGS. 2 and 4, the lead wire 102 is electrically connected to the second electrode 83 of the pressure measurement member 80, passes through the other cutout groove 64 of the positioning member 60, the other vertical groove 91a of the fixing member 91, and the penetration path 14 of the external housing 10, and is guided to the connector 110 in a state of being insulated from the external housing 10 and derived.

That is, the second electrode 83 is connected to a terminal 113 of the connector 110 via the lead wire 102 and is electrically connected to the electric circuit on an output side (positive side) via the external connector.

As illustrated in FIG. 2, the connector 110 includes a joint part 111 joined to the connector coupling part 17 of the external housing 10, the terminal 112 fixed to the joint part 111 and electrically connected to the lead wire 101, and the terminal 113 fixed to the terminal 112 with an insulation member therebetween and electrically connected to the lead wire 102.

The terminals 112 and 113 are set to be respectively connected to connection terminals of the external connector.

Next, assembly work of the pressure sensor having the foregoing constitution will be described.

During the work, the external housing 10, the sub-housing 20, the diaphragm 30, the heat shielding plate 40, an annular member 45, the holding plate 50, the positioning member 60, the heat insulation member 70, the first electrode 81, the piezoelectric substance 82, the second electrode 83, the fixing member 91, the insulation member 92, the lead wire 101, the lead wire 102, and the connector 110 are prepared.

First, the flexible plate-shaped part 31 of the diaphragm 30 is fixed to the end surface 23 of the sub-housing 20 by welding or the like.

Next, the holding plate 50 and the positioning member 60 are fitted into the sub-housing 20. Subsequently, the heat insulation member 70, the first electrode 81 to which the lead wire 101 is connected, the piezoelectric substance 82, the second electrode 83 to which the lead wire 102 is connected, and the insulation member 92 are stacked in this order and are fitted into the positioning member 60.

The lead wires 101 and 102 may be respectively connected to the first electrode 81 and the second electrode 83 in the following step.

Thereafter, the fixing member 91 is fitted into the sub-housing 20 such that the insulation member 92 is pressed, and the fixing member 91 is fixed to the sub-housing 20 by welding or the like in a state in which a preload is applied thereto.

Accordingly, as illustrated in FIGS. 4 and 5, a sensor module M is formed.

A method of assembling the sensor module M is not limited to the foregoing procedure. The holding plate 50, the heat insulation member 70, the first electrode 81, the piezoelectric substance 82, the second electrode 83, and the insulation member 92 may be embedded into the positioning member 60 in advance, and the positioning member 60 into which the foregoing various components are embedded may be fitted into the sub-housing 20 and fixed to the sub-housing 20 by welding or the like in a state in which the fixing member 91 applies a preload.

Subsequently, the sensor module M is embedded into the external housing 10. That is, the lead wires 101 and 102 pass through the penetration path 14 of the external housing 10, and the sub-housing 20 is fitted to the fitting inner circumferential wall 12 of the external housing 10. Then, the end surface 24 abuts the step part 13. Thereafter, the sub-housing 20 is fixed to the external housing 10 by welding.

In this state, as illustrated in FIGS. 4 and 5, a relationship between the diaphragm 30 and the external housing 10 is a disposition relationship in which an annular clearance C is defined between the inner circumferential wall 11a of the tip tubular part 11 and an outer circumferential surface 31a of the flexible plate-shaped part 31.

That is, the tip tubular part 11 is formed such that the clearance C is defined between the tip tubular part 11 and the outer circumferential surface 31a of the flexible plate-shaped part 31 in the radial direction.

In this manner, heat transferred from the tip tubular part 11 of the external housing 10 to the diaphragm 30 can be efficiently curbed by forming the clearance C.

Subsequently, the heat shielding plate 40 is fitted to the inner side of the tip tubular part 11 such that the diaphragm 30 is covered from the outer side in the axis S direction, and the disk-shaped contact part 41 is disposed such that it comes into contact with the central region corresponding to the transfer part 32 of the diaphragm 30.

Further, in the tip tubular part 11 of the external housing 10, the tip part 11b is bent toward the axis S such that the outer circumferential edge part 42b of the heat shielding plate 40 is held, thereby being subjected to caulking processing.

In this manner, by bending the tip tubular part 11, the high-temperature pressure medium can be prevented from entering the inside of the void Vs from an area around the outer circumferential edge part 42b and the outer circumferential surface 42a of the heat shielding plate 40, and the heat shielding plate 40 can be held in a state of coming into contact with the diaphragm 30.

Accordingly, the diaphragm 30 can be protected from the high-temperature pressure medium, thermal distortion can be curbed, degradation of the sensor accuracy due to influence of heat can be curbed or prevented, and a pressure of the high-temperature pressure medium can be detected with high accuracy.

Subsequently, the joint part 111 is fixed to the connector coupling part 17 of the external housing 10.

Subsequently, the lead wire 101 is connected to the terminal 112. Thereafter, the terminal 112 is fixed to the joint part 111.

Subsequently, the lead wire 102 is connected to the terminal 113. Thereafter, the terminal 113 is fixed to the terminal 112 with the insulation member therebetween. Accordingly, the connector 110 is fixed to the external housing 10.

This completes assembly of the pressure sensor.

The foregoing assembly procedure is an example and is not limited thereto, and other assembly procedures may be employed.

In the pressure sensor according to the foregoing first embodiment, the heat shielding plate 40 formed as a member independent from the diaphragm 30 is held by the external housing 10 such that the diaphragm 30 is covered, and is disposed such that it comes into contact with the diaphragm 30 in the central region corresponding to the transfer part 32 and the annular void Vs is defined between the heat shielding plate 40 and the flexible plate-shaped part 31 in a region other than the central region. Therefore, heat transfer to the effective part A of the diaphragm 30 can be curbed.

Specifically, due to heat received from the high-temperature pressure medium, the heat shielding plate 40 repeats expansion and contraction alone and releases heat, and the void Vs functions as an effective thermal barrier. Therefore, heat transfer to the diaphragm 30 can be effectively curbed.

Accordingly, distortion of the diaphragm 30 due to thermal expansion can be curbed or prevented, a sensor error of the pressure measurement member 80 can be reduced, and a pressure of the high-temperature pressure medium can be detected with high accuracy.

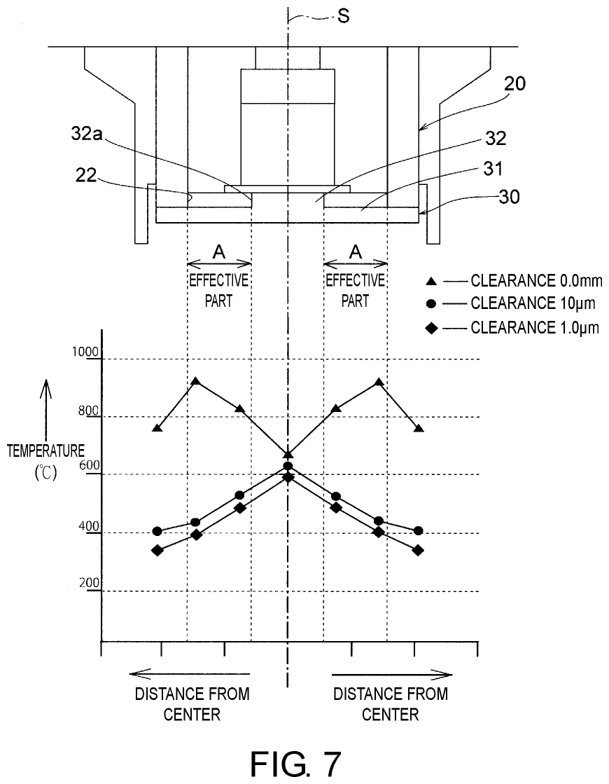

Particularly, since the heat shielding plate 40 comes into contact with the central region corresponding to the transfer part 32 of the diaphragm 30 and defines the void Vs without coming into contact with a region other than the central region, as illustrated in FIG. 7, temperature rise of the diaphragm 30 can be curbed.

FIG. 7 illustrates simulation results of a temperature distribution of the diaphragm 30 when a clearance between a region other than the central region (a circular region having the diameter 2r) corresponding to the transfer part 32 of the diaphragm 30 and the heat shielding plate 40 is changed to 0.0 mm, 10 μm, and 1.0 mm.

As is obvious from the results, when the clearance is 0.0 mm, there is a significant temperature rise of the effective part A of the diaphragm 30.

On the other hand, when the clearance is 10 μm and 1.0 mm, compared to the case in which the clearance is 0.0 mm, the temperature falls in the effective part A of the diaphragm 30 within a range of several hundred degrees.

That is, thermal deformation of the effective part A in the diaphragm 30 can be curbed by providing the heat shielding plate 40 defining the void Vs in a region other than the central region corresponding to the transfer part 32 of the diaphragm 30.

In addition, heat transferred to the diaphragm 30 is thermally insulated by the heat insulation member 70, and thus heat transfer from the diaphragm 30 to the first electrode 81 and the piezoelectric substance 82 is curbed. Therefore, the influence of heat on the piezoelectric substance 82 is curbed, fluctuation of the reference point (zero point) of a sensor output can be prevented, and expected sensor accuracy can be obtained.

Here, the heat insulation member 70 is formed of an insulating material, the first electrode 81 is directly connected to the electric circuit via the lead wire 101, and the second electrode 83 is directly connected to the electric circuit via the lead wire 102. Therefore, generation of a leakage current can be prevented and expected sensor characteristics can be maintained.

Moreover, the housing includes the external housing 10 and the sub-housing 20 fitted and fixed to the inner side of the external housing 10, and the diaphragm 30, the holding plate 50, the positioning member 60, the heat insulation member 70, the pressure measurement member 80, and the preload applying member 90 are disposed in the sub-housing 20.

According to this, the sensor module M can be formed by embedding the diaphragm 30, the holding plate 50, the positioning member 60, the heat insulation member 70, the pressure measurement member 80, and the preload applying member 90 into the sub-housing 20 in advance.

Therefore, when an attachment shape or the like varies depending on an application object, the sensor module M can be shared by setting only the external housing 10 for each application object.

As described above, in the pressure sensor according to the first embodiment, the diaphragm 30 can be protected from the high-temperature pressure medium, thermal distortion can be curbed, degradation of the sensor accuracy due to influence of heat can be curbed or prevented, and a pressure of the high-temperature pressure medium can be detected with high accuracy.

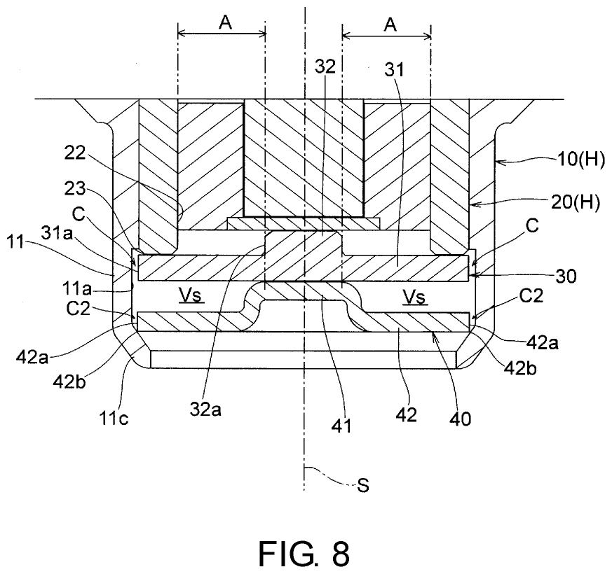

FIG. 8 illustrates a pressure sensor according to a second embodiment, which is the same as the first embodiment except that a form of holding the heat shielding plate 40 is changed. The same reference signs are applied to the same constitutions as the first embodiment, and description thereof will be omitted.

In the second embodiment, the tip tubular part 11 comes into line contact with the outer circumferential edge part 42b of the annular isolation part 42 to define a clearance C2 between the tip tubular part 11 and the outer circumferential surface 42a of the annular isolation part 42 in the radial direction and is bent to hold the heat shielding plate 40.

That is, a tip part 11c of the tip tubular part 11 is subjected to caulking processing in a manner of being inclined with respect to the outer circumferential surface 42a of the heat shielding plate 40, the inner circumferential wall 11a comes into contact with the outer circumferential edge part 42b of the annular isolation part 42, and the heat shielding plate 40 is held on the inner side of the tip tubular part 11.

Accordingly, the clearance C2 is defined between the inner circumferential wall 11a of the tip tubular part 11 and the outer circumferential surface 42a of the heat shielding plate 40. Therefore, when the heat shielding plate 40 thermally expands, direct influence of deformation of the heat shielding plate 40 on the diaphragm 30 can be curbed or prevented by causing an expanded portion to escape to the clearance C2.

In the pressure sensor according to the second embodiment, similar to the first embodiment, the diaphragm 30 can be protected from the high-temperature pressure medium, thermal distortion can be curbed, degradation of the sensor accuracy due to influence of heat can be curbed or prevented, and a pressure of the high-temperature pressure medium can be detected with high accuracy.

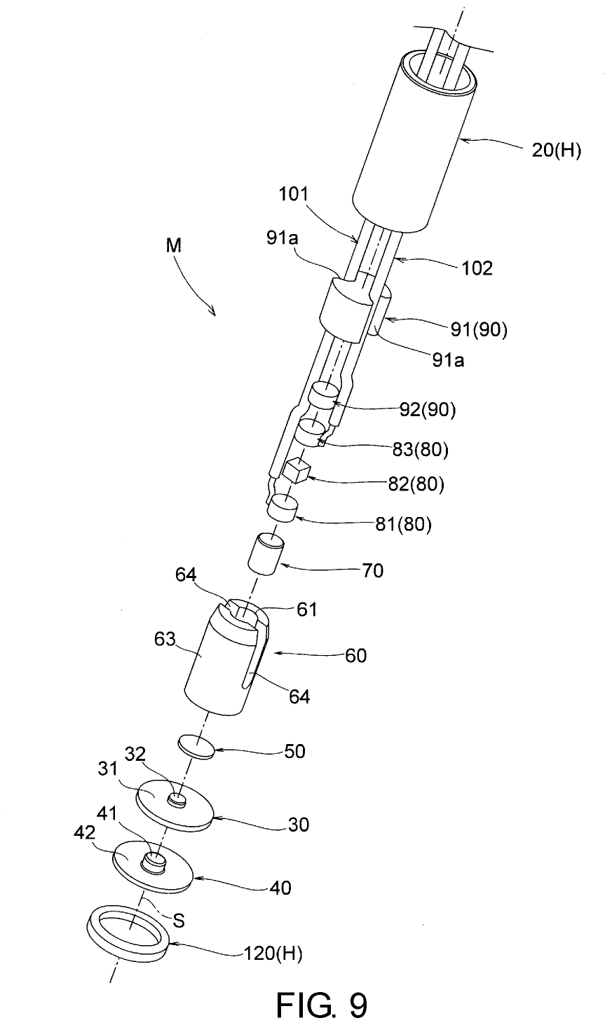

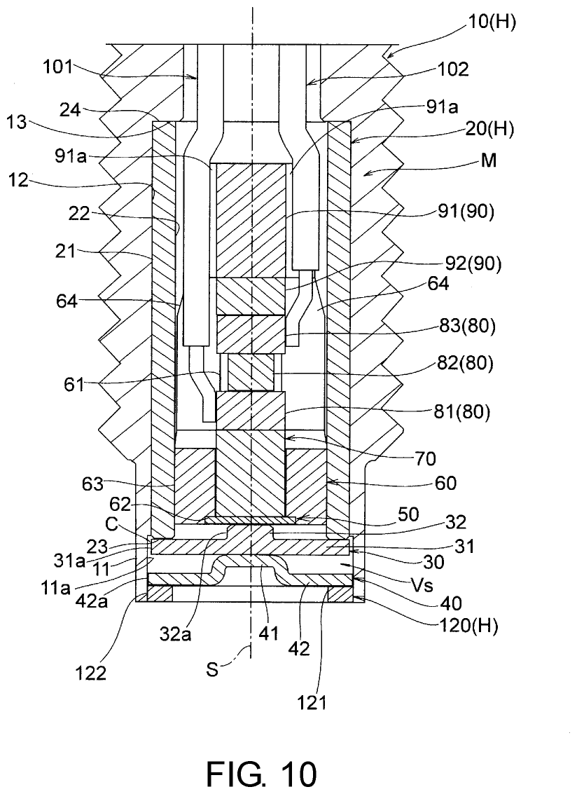

FIGS. 9 and 10 illustrate a pressure sensor according to a third embodiment, which is the same as the first embodiment except that a ring member 120 constituting a portion of the housing H to hold the heat shielding plate 40 is employed. The same reference signs are applied to the same constitutions as the first embodiment, and description thereof will be omitted.

In the pressure sensor according to the third embodiment, the housing H includes the ring member 120 disposed on the tip side in the axis S direction from the heat shielding plate 40 and holds the heat shielding plate 40, in addition to the external housing 10 and the sub-housing 20.

Using the same material as that of the heat shielding plate 40, for example, a metal material such as austenitic stainless steel (SUS304), the ring member 120 is formed as a toric flat plate when viewed in the axis S direction and includes an opening part 121 and an outer circumferential surface 122, as illustrated in FIG. 10.

The outer diameter dimension of the ring member 120 is formed to have a size which comes into tight contact with and is fitted to the inner side of the tip tubular part 11 of the external housing 10, that is, an outer diameter dimension equivalent to the inner diameter dimension of the inner circumferential wall 11a. In addition, the inner diameter dimension of the opening part 121 need only be a dimension allowing the disk-shaped contact part 41 of the heat shielding plate 40 to be exposed. Here, the opening part 121 is formed to have an inner diameter dimension equivalent to that of the inner circumferential wall 22 of the sub-housing 20.

The ring member 120 is disposed adjacent to the heat shielding plate 40 from the outer side in the axis S direction, and the outer circumferential surface 122 is welded to the inner circumferential wall 11a of the tip tubular part 11 and fixed to the external housing 10 in a state in which the disk-shaped contact part 41 of the heat shielding plate 40 is pressed in a manner of being brought into contact with the diaphragm 30.

Here, since the material of the ring member 120 is the same as the material of the heat shielding plate 40, thermal characteristics can be prevented from differing therebetween, and the heat shielding plate 40 can stably come into contact with the diaphragm 30 and can be held.

In the pressure sensor according to the third embodiment, similar to the first embodiment, the diaphragm 30 can be protected from the high-temperature pressure medium, thermal distortion can be curbed, degradation of the sensor accuracy due to influence of heat can be curbed or prevented, and a pressure of the high-temperature pressure medium can be detected with high accuracy.

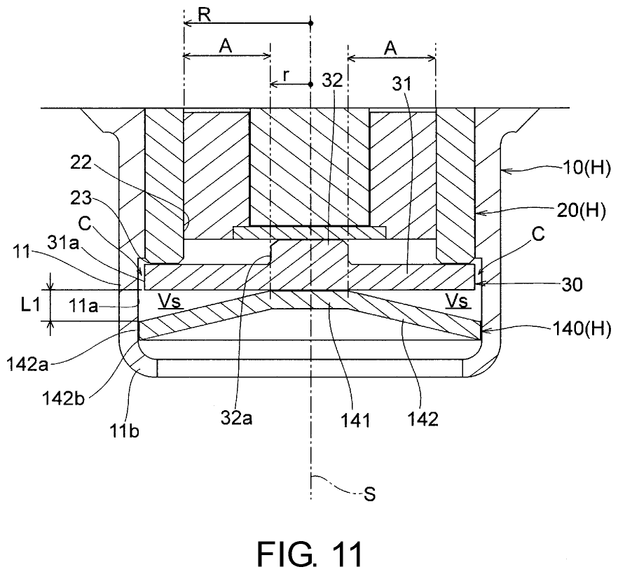

FIG. 11 illustrates a modification example of a heat shielding plate.

A heat shielding plate 140 according to this modification example is formed of the same material as that of the heat shielding plate 40 described above and includes a disk-shaped contact part 141 and an annular isolation part 142.

Similar to the disk-shaped contact part 41 described above, the disk-shaped contact part 141 is formed to have a disk shape coming into contact with the diaphragm 30 in the central region corresponding to the transfer part 32 of the diaphragm 30 and having an outer diameter of 2r.

The annular isolation part 142 has a conic plate shape formed to be connected to the disk-shaped contact part 141, bent in a manner of being inclined at a predetermined angle, and defining a portion of a conic surface and is disposed in a manner of being isolated from the flexible plate-shaped part 31 by a gap L1 at the maximum to define the annular void Vs between the annular isolation part 142 and the diaphragm 30 in a region other than the central region corresponding to the transfer part 32, that is, such that it is disposed in a manner of being isolated from the flexible plate-shaped part 31 and the annular void Vs is defined between the annular isolation part 142 and the diaphragm 30.

As the gap L1 increases, the void Vs increases and a heat insulating effect is enhanced. However, in consideration of miniaturization, limitations on a layout, and a required heat insulating effect, the gap L1 is set to have a value within a range of approximately one to two times the plate thickness of the heat shielding plate 40.

The gap L1 is not limited to the foregoing value and may be set to have other values as long as other limitations are allowed.

Further, as illustrated in FIG. 11, the heat shielding plate 140 is inserted into the tip tubular part 11 of the external housing 10, the disk-shaped contact part 141 overlaps the central region of the diaphragm 30 such that it comes into contact therewith from the outer side in the axis S direction, the tip part 11b of the tip tubular part 11 is subjected to caulking processing, and in a state in which an outer circumferential surface 142a of the annular isolation part 142 comes into contact with the inner circumferential wall 11a of the tip tubular part 11, an outer circumferential edge part 142b is in a state of being held by the external housing 10.

That is, the heat shielding plate 140 is disposed such that the diaphragm 30 exposed to the high-temperature pressure medium (high-temperature combustion gas) is covered from the outer side in the axis S direction and is held by the external housing 10 without being fixed thereto by welding or the like while the void Vs is sealed.

In the pressure sensor including the heat shielding plate 140 according to this modification example, similar to the first embodiment to the third embodiment, the diaphragm 30 can be protected from the high-temperature pressure medium, thermal distortion can be curbed, degradation of the sensor accuracy due to influence of heat can be curbed or prevented, and a pressure of the high-temperature pressure medium can be detected with high accuracy.

In the foregoing embodiments, the heat shielding plates 40 and 140 having the foregoing forms have been described as a heat shielding plate, but it is not limited thereto. A heat shielding plate having a different form may be employed as long as a void can be defined between the heat shielding plate and the diaphragm 30 in a region other than the central region corresponding to the transfer part 32 of the diaphragm 30.

In the foregoing embodiments, the diaphragm 30 integrally including the flexible plate-shaped part 31 and the transfer part 32 has been described as a diaphragm, but it is not limited thereto. A constitution in which the flexible plate-shaped part 31 and the transfer part 32 are independently formed, the flexible plate-shaped part 31 functions as a diaphragm, and the transfer part 32 functions as a force transfer member may be employed.

In the foregoing embodiments, a constitution including the external housing 10 and the sub-housing 20 has been described as a housing, but it is not limited thereto. One housing may be employed.

In the foregoing embodiments, the diaphragm 30 having the pillar-shaped transfer part 32 has been described as a diaphragm, but it is not limited thereto. As long as a load is transferred to the pressure measurement member, a transfer part having a form other than a pillar shape may be employed, and a heat shielding plate defining an annular void between the transfer part and the diaphragm in a region other than the central region corresponding to the transfer part may be employed.

As described above, the pressure sensor of the disclosure is capable of curbing thermal distortion by protecting a diaphragm from a high-temperature pressure medium and detecting a pressure of the high-temperature pressure medium with high accuracy by curbing or preventing degradation of sensor accuracy due to influence of heat. Therefore, particularly, it can be naturally applied as a pressure sensor for detecting a pressure of a high-temperature pressure medium such as a combustion gas inside a combustion chamber of an engine, and it is also useful as a pressure sensor for detecting a pressure of a high-temperature pressure medium other than a combustion gas or other pressure media.

Other Configurations

In one aspect, a pressure sensor of the disclosure has a constitution including a cylindrical housing that defines an axis; a pressure measurement member that is accommodated inside the cylindrical housing and includes a piezoelectric substance; a diaphragm that has a flexible plate-shaped part fixed to a tip side of the cylindrical housing and a transfer part protruding on the axis to transfer a load to the pressure measurement member; and a heat shielding plate that is held by the cylindrical housing such that the diaphragm is covered, comes into contact with the diaphragm in a central region corresponding to the transfer part, and defines an annular void between the heat shielding plate and the diaphragm in a region other than the central region.

The pressure sensor may employ a constitution in which the transfer part has a pillar shape centering on the axis, and the heat shielding plate includes a disk-shaped contact part centering on the axis and coming into contact with a region having a contour corresponding to an outer diameter of the transfer part, and an annular isolation part connected to the disk-shaped contact part and defining the annular void by being disposed in a manner of being isolated from the flexible plate-shaped part.

The pressure sensor may employ a constitution in which the cylindrical housing comes into line contact with an outer circumferential edge part of the annular isolation part and is formed such that the heat shielding plate is held to define a clearance with respect to an outer circumferential surface of the annular isolation part.

The pressure sensor may employ a constitution in which the cylindrical housing includes an end surface to which the flexible plate-shaped part is fixed in a direction of the axis, and a tip tubular part which extends to the tip side in the direction of the axis beyond the end surface on an outer side in a radial direction from the end surface, and the heat shielding plate is held on an inner side of the tip tubular part.

The pressure sensor may employ a constitution in which the tip tubular part is formed such that a clearance is defined between the tip tubular part and an outer circumferential surface of the flexible plate-shaped part.

The pressure sensor may employ a constitution in which the tip tubular part has a tip part subjected to caulking processing to hold the heat shielding plate.

The pressure sensor may employ a constitution in which the cylindrical housing includes a ring member disposed on the tip side in the direction of the axis from the heat shielding plate and holding the heat shielding plate, and the ring member is fixed to the tip tubular part.

The pressure sensor may employ a constitution in which the cylindrical housing includes an external housing and a sub-housing fitted and fixed to an inner side of the external housing, the sub-housing accommodates the pressure measurement member and has the end surface, and the external housing has the tip tubular part.

The pressure sensor may employ a constitution in which the pressure measurement member includes a first electrode and a second electrode which are stacked such that the piezoelectric substance is sandwiched, a first conductor derived in a state of being insulated from the cylindrical housing is connected to the first electrode, and a second conductor derived in a state of being insulated from the cylindrical housing is connected to the second electrode.

According to the pressure sensor having the foregoing constitution, it is possible to obtain a pressure sensor capable of curbing thermal distortion by protecting a diaphragm from a high-temperature pressure medium, capable of curbing or preventing degradation of sensor accuracy due to influence of heat, and capable of detecting a pressure of the high-temperature pressure medium with high accuracy.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A pressure sensor, comprising:
a cylindrical housing that defines an axis;
a pressure measurement member that is accommodated inside the cylindrical housing and includes a piezoelectric substance;
a diaphragm that has a flexible plate-shaped part fixed to a tip side of the cylindrical housing and a transfer part protruding on the axis to transfer a load to the pressure measurement member; and
a heat shielding plate that is held by the cylindrical housing such that the diaphragm is covered, comes into contact with the diaphragm in a central region corresponding to the transfer part, and defines an annular void between the heat shielding plate and the diaphragm in a region other than the central region.

2. The pressure sensor according to claim 1,
wherein the transfer part has a pillar shape centering on the axis, and
the heat shielding plate comprises a disk-shaped contact part centering on the axis and coming into contact with a region having a contour corresponding to an outer diameter of the transfer part, and an annular isolation part connected to the disk-shaped contact part and defining the annular void by being disposed in a manner of being isolated from the flexible plate-shaped part.

3. The pressure sensor according to claim 2,
wherein the cylindrical housing comes into line contact with an outer circumferential edge part of the annular isolation part and is formed such that the heat shielding plate is held to define a clearance with respect to an outer circumferential surface of the annular isolation part.

4. The pressure sensor according to claim 1,
wherein the cylindrical housing comprises an end surface to which the flexible plate-shaped part is fixed in a direction of the axis, and a tip tubular part which extends to the tip side in the direction of the axis beyond the end surface on an outer side in a radial direction from the end surface, and
the heat shielding plate is held on an inner side of the tip tubular part.

5. The pressure sensor according to claim 2,
wherein the cylindrical housing comprises an end surface to which the flexible plate-shaped part is fixed in a direction of the axis, and a tip tubular part which extends to the tip side in the direction of the axis beyond the end surface on an outer side in a radial direction from the end surface, and
the heat shielding plate is held on an inner side of the tip tubular part.

6. The pressure sensor according to claim 3,
wherein the cylindrical housing comprises an end surface to which the flexible plate-shaped part is fixed in a direction of the axis, and a tip tubular part which extends to the tip side in the direction of the axis beyond the end surface on an outer side in a radial direction from the end surface, and
the heat shielding plate is held on an inner side of the tip tubular part.

7. The pressure sensor according to claim 4,
wherein the tip tubular part is formed such that a clearance is defined between the tip tubular part and an outer circumferential surface of the flexible plate-shaped part.

8. The pressure sensor according to claim 4,
wherein the tip tubular part has a tip part subjected to caulking processing to hold the heat shielding plate.

9. The pressure sensor according to claim 7,
wherein the tip tubular part has a tip part subjected to caulking processing to hold the heat shielding plate.

10. The pressure sensor according to claim 4,
wherein the cylindrical housing comprises a ring member disposed on the tip side in the direction of the axis from the heat shielding plate and holding the heat shielding plate, and
the ring member is fixed to the tip tubular part.

11. The pressure sensor according to claim 7,
wherein the cylindrical housing comprises a ring member disposed on the tip side in the direction of the axis from the heat shielding plate and holding the heat shielding plate, and
the ring member is fixed to the tip tubular part.

12. The pressure sensor according to claim 4,
wherein the cylindrical housing comprises an external housing and a sub-housing fitted and fixed to an inner side of the external housing,
the sub-housing accommodates the pressure measurement member and has the end surface, and
the external housing has the tip tubular part.

13. The pressure sensor according to claim 7,
wherein the cylindrical housing comprises an external housing and a sub-housing fitted and fixed to an inner side of the external housing,
the sub-housing accommodates the pressure measurement member and has the end surface, and
the external housing has the tip tubular part.

14. The pressure sensor according to claim 8,
wherein the cylindrical housing comprises an external housing and a sub-housing fitted and fixed to an inner side of the external housing,
the sub-housing accommodates the pressure measurement member and has the end surface, and
the external housing has the tip tubular part.

15. The pressure sensor according to claim 10,
wherein the cylindrical housing comprises an external housing and a sub-housing fitted and fixed to an inner side of the external housing,
the sub-housing accommodates the pressure measurement member and has the end surface, and
the external housing has the tip tubular part.

16. The pressure sensor according to claim 1,
wherein the pressure measurement member comprises a first electrode and a second electrode which are stacked such that the piezoelectric substance is sandwiched,
a first conductor derived in a state of being insulated from the cylindrical housing is connected to the first electrode, and
a second conductor derived in a state of being insulated from the cylindrical housing is connected to the second electrode.

17. The pressure sensor according to claim 2,
wherein the pressure measurement member comprises a first electrode and a second electrode which are stacked such that the piezoelectric substance is sandwiched,
a first conductor derived in a state of being insulated from the cylindrical housing is connected to the first electrode, and
a second conductor derived in a state of being insulated from the cylindrical housing is connected to the second electrode.

18. The pressure sensor according to claim 3,
wherein the pressure measurement member comprises a first electrode and a second electrode which are stacked such that the piezoelectric substance is sandwiched,
a first conductor derived in a state of being insulated from the cylindrical housing is connected to the first electrode, and
a second conductor derived in a state of being insulated from the cylindrical housing is connected to the second electrode.

19. The pressure sensor according to claim 4,
wherein the pressure measurement member comprises a first electrode and a second electrode which are stacked such that the piezoelectric substance is sandwiched,
a first conductor derived in a state of being insulated from the cylindrical housing is connected to the first electrode, and
a second conductor derived in a state of being insulated from the cylindrical housing is connected to the second electrode.

20. The pressure sensor according to claim 7,
wherein the pressure measurement member comprises a first electrode and a second electrode which are stacked such that the piezoelectric substance is sandwiched,
a first conductor derived in a state of being insulated from the cylindrical housing is connected to the first electrode, and
a second conductor derived in a state of being insulated from the cylindrical housing is connected to the second electrode.
